(19) United States
(12) Patent Application Publication
(10) Pub. No.: US 2024/0190362 A1
(43) Pub. Date: Jun. 13, 2024

(54) INTERIOR TRIM MOUNTING BRACKET FOR AUTOMOTIVE VEHICLE

(71) Applicant: KASAI KOGYO CO., LTD., Kanagawa (JP)

(72) Inventor: Masashi FUJII, Ota-shi, Gunma (JP)

(21) Appl. No.: 18/551,517

(22) PCT Filed: Mar. 26, 2021
(86) PCT No.: PCT/JP2021/012785

§ 371 Date: Sep. 20, 2023

(51) Int. Cl. B60R 13/02

(52) U.S. Cl. CPC B60R 13/0206

(57) ABSTRACT

The trim attachment bracket includes, as bracket function portions, at least a joined portion joined to the automobile interior trim, a clip arrangement portion where a clip fitted into an attachment hole in a vehicle body panel is arranged, and a contact portion contacting against the vehicle body panel. The trim attachment bracket includes a bridging portion connecting the bracket function portions to each other. A portion other than the bracket function portions and the bridging portion is opened as a hole having a predetermined shape while the bracket function portions and the bridging portion are maintained.

### CROSS-REFERENCE TO RELATED APPLICATIONS

This application is a National Stage Entry application of PCT International Application No. PCT/JP2021/012785, filed on Mar. 26, 2021, the entire contents of which are hereby incorporated by reference.

### BACKGROUND

### 1. Technical Field

The present invention relates to an automobile interior trim attachment bracket used as means for attaching, to a vehicle body panel of an automobile, an automobile interior trim formed into a predetermined shape. More particularly, the present invention relates to the automobile interior trim attachment bracket suitable for reducing a defect in fixing of the trim attachment bracket and for improving precision in a fixed position of the trim attachment bracket when the trim attachment bracket is joined and fixed to the automobile interior trim.

### 2. Description of the Background

Conventionally, an automobile interior trim formed into a predetermined shape is attached to a vehicle body panel of an automobile, on the vehicle interior side (refer to FIG. 1 in Japanese Patent Application Laid-open Publication No. 2007-223420, hereinafter referred to as Patent Literature 1). This type of automobile interior trims include an automobile interior trim formed of a material that is thin and that has a low bending rigidity. Such an automobile interior trim is called a soft trim, and is adopted in a trunk room of an automobile, for example.

A trim attachment bracket illustrated in FIG. 3 (hereinafter, referred to as “conventional trim attachment bracket 100”) is used in a case of attaching, to a vehicle body panel of an automobile, an automobile interior trim (hereinafter, referred to as “automobile interior soft trim T”) constituted by a soft trim as described above.

FIG. 3 is a back surface view of the conventional trim attachment bracket. FIG. 4 is an illustration of a state where the conventional trim attachment bracket is joined and fixed to an automobile interior trim.

Referring to FIG. 3, the conventional trim attachment bracket 100 includes a functional configuration having a bending rigidity higher than that of the soft trim. The functional configuration is not provided in the soft trim. Specifically, the functional configuration is, for example, a clip arrangement portion 4 for arranging a clip C. The clip C is fitted into an attachment hole in the vehicle body panel.

When the automobile interior soft trim T is attached to the vehicle body panel, the conventional trim attachment bracket 100 is previously fixed to the automobile interior soft trim T by a hot-melt adhesive, welding, or the like, as illustrated in FIG. 4. Then, the clip C installed to the clip arrangement portion 4 of the conventional trim attachment bracket 100 is fitted into the attachment hole of the vehicle body panel (not illustrated in the drawing). Thereby, work of attaching the automobile interior soft trim T to the vehicle body panel is completed.

However, the automobile interior soft trim T has a shape curved in a wide area thereof. The conventional trim attachment bracket 100 also has a widely curved shape in conformity to such curving. The conventional trim attachment bracket 100 and the automobile interior soft trim T that are widely curved in such a manner are easily deformed. For these reasons, it is difficult to precisely join and fix, to each other, the curved surfaces of the conventional trim attachment bracket 100 and the automobile interior soft trim T.

Particularly, the conventional trim attachment bracket 100 is formed of a resin. The conventional trim attachment bracket 100 is warped and deformed due to surface shrinkage in the forming process. Thus, the conventional trim attachment bracket 100 has a problem such as easy occurrence of a defect in fixing of the trim attachment bracket to the automobile interior trim. An example of the defect is occurrence of an unnecessary gap G between the conventional trim attachment bracket 100 and the automobile interior soft trim T that are joined to each other. The gap G is illustrated in FIG. 5, for example.

### BRIEF SUMMARY

The present invention has been made to solve the above-described problem. An object of the present invention is to provide an automobile interior trim attachment bracket suitable for reducing a defect in fixing of the trim attachment bracket and for improving precision in a fixed position of the trim attachment bracket when the trim attachment bracket is joined and fixed to an automobile interior trim.

In order to accomplish the above-described object, the present invention is an automobile interior trim attachment bracket used as means for attaching an automobile interior trim to a vehicle body panel. The automobile interior trim is formed into a predetermined shape. The attachment bracket includes at least a joined portion, a clip arrangement portion, and a contact portion that are bracket function portions. The joined portion is joined to the automobile interior trim. A clip is arranged at the clip arrangement portion. The clip is fitted into an attachment hole in the vehicle body panel. The contact portion is caused to contact against the vehicle body panel. The trim attachment bracket includes a bridging portion that connects the bracket function portions to each other. A portion other than the bracket function portions and the bridging portion is opened as a hole having a predetermined shape while the bracket function portions and the bridging portion are maintained.

According to the present invention, the trim attachment bracket has, as a specific configuration of the automobile interior trim attachment bracket, the structure in which the portion other than the bracket function portions and the bridging portion is opened as the hole having the predetermined shape. Thereby, (1) a ratio of a surface area occupied by a resin to an entire surface area (including a surface open area of the opening) in the trim attachment bracket is reduced while a dimension (size) and the function portions necessary for the trim attachment bracket are maintained. (2) A rigidity of the entire trim attachment bracket excluding the function portions becomes relatively low. Thereby, the trim attachment bracket itself becomes flexible, and easily conforms to a shape of the automobile interior trim. (3) Surface shrinkage of the trim attachment bracket caused by cooling solidification when the trim attachment bracket is formed from a molten resin is effectively reduced. Entire or partial warping of the trim attachment bracket due to this surface shrinkage is effectively reduced. For these reasons, it is possible to provide the automobile interior trim attachment bracket suitable for preventing a defect in fixing of the trim attachment bracket to the automobile interior trim, and for improving precision in a fixed position of the attachment bracket.

### BRIEF DESCRIPTION OF DRAWINGS

FIG. 1 is a back surface view of an automobile interior trim attachment bracket to which the present invention has been applied.

FIG. 2 is an illustration of a state where the automobile interior trim attachment bracket of FIG. 1 is joined and fixed to an automobile interior trim.

FIG. 3 is a back surface view of a conventional trim attachment bracket.

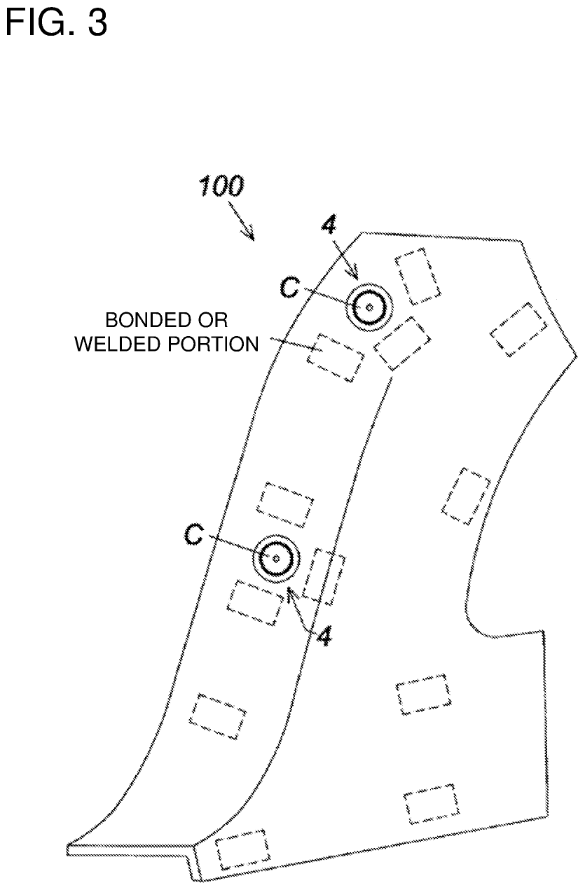

FIG. 4 is an illustration of a state where the conventional trim attachment bracket is joined and fixed to an automobile interior trim.

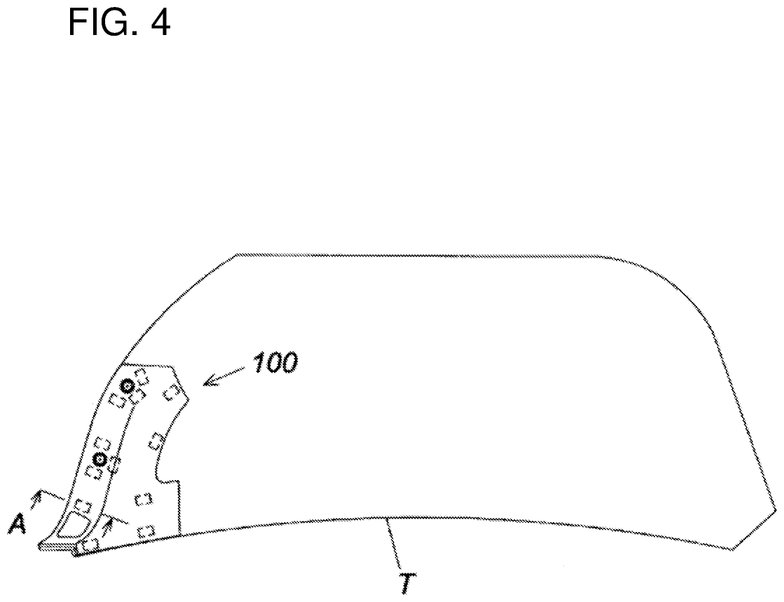

FIG. 5 is an A-arrow sectional view in FIG. 4.

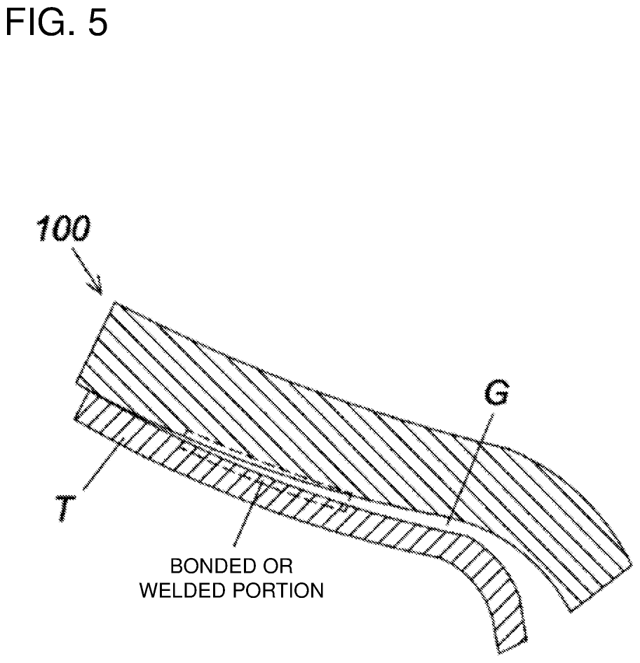

FIG. 6 is an illustration of a surface shrinkage direction in the conventional trim attachment bracket.

### DETAILED DESCRIPTION

Hereinafter, the best mode for carrying out the present invention is described in detail, with reference to the accompanying drawings.

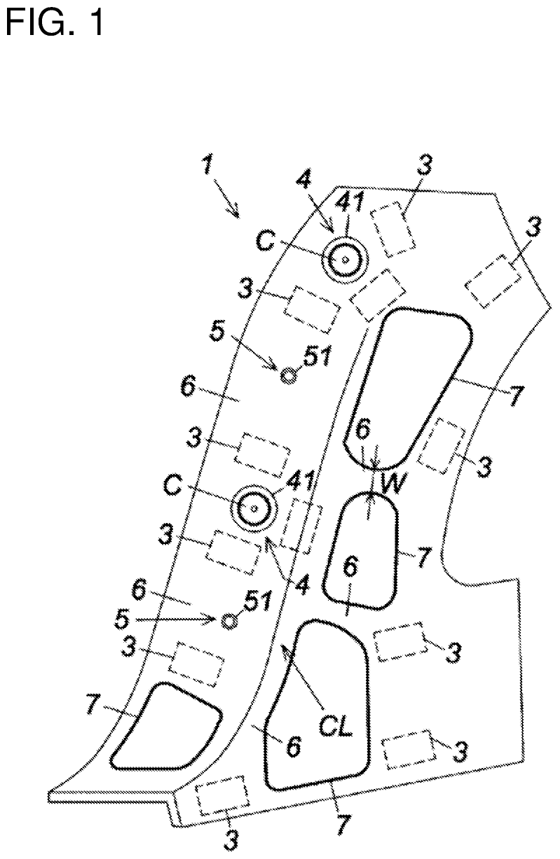

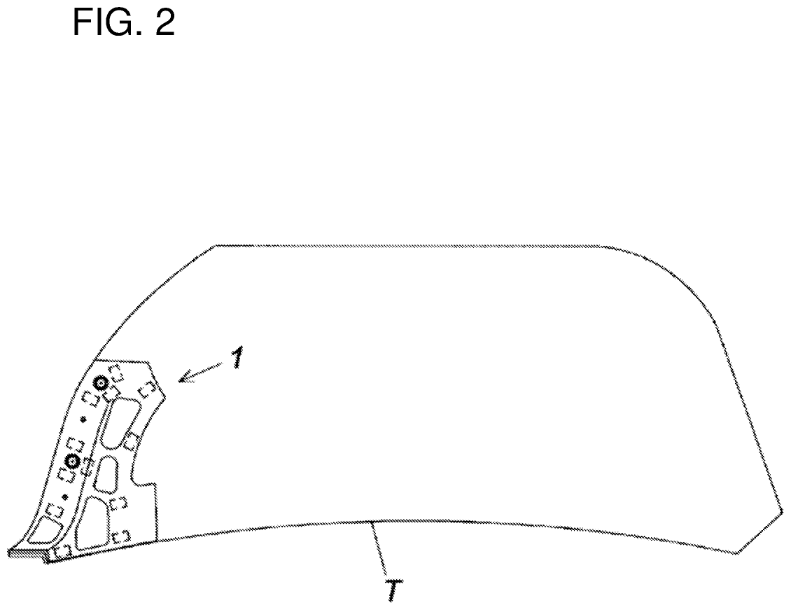

FIG. 1 is a back surface view of an automobile interior trim attachment bracket to which the present invention has been applied. FIG. 2 is an illustration of a state where the automobile interior trim attachment bracket of FIG. 1 is joined and fixed to an automobile interior trim.

### Description of Application

Referring to FIG. 1 and FIG. 2, the automobile interior trim attachment bracket 1 (hereinafter, referred to as “trim attachment bracket 1”) of FIG. 1 is used as means for attaching the automobile interior trim T to a vehicle body panel (not illustrated in the drawings) of an automobile, as illustrated in FIG. 2. The automobile interior trim T is formed into a predetermined shape. The automobile interior trim T is configured as what is called a soft trim described below. The automobile interior trim T is attached to the vehicle body panel of an automobile trunk room, for example, and is used. However, there is no limitation to this example of attachment use.

### Description of Material

The automobile interior trim T is what is called a soft trim. The soft trim has a low bending rigidity. The automobile interior trim T is formed of a material that is a mixture of a resin and a fiber. For this reason, the automobile interior trim T does not have a function of allowing direct installation of the clip 2 (refer to FIG. 2). The clip 2 is necessary for attaching the automobile interior trim T to the vehicle body panel. The above-mentioned function is provided in the trim attachment bracket 1 as described below. Meanwhile, the trim attachment bracket 1 is formed of a PP resin, an ABS resin, or the like. The trim attachment bracket 1 has a bending rigidity much higher than that of the soft trim.

Examples cited as the soft trim include a soft trim formed of a mixture of a PP resin and an PET resin mixed at a ratio of 7:3, and a soft trim formed of a mixture of a PP resin and an PET resin mixed at a ratio of 6:4 or 8:2. However, there is no limitation to these.

### Outline of Main Functions

The trim attachment bracket 1 of FIG. 1 includes a joined portion 3, a clip arrangement portion 4, and a contact portion 5 that are portions (hereinafter, referred to as “bracket function portions”) having main functions of the trim attachment bracket 1. The joined portion 3 is joined to the automobile interior trim T. The clip C is arranged at the clip arrangement portion 4. The clip C is fitted into an attachment hole in the unillustrated vehicle body panel. The contact portion 5 is caused to contact against the vehicle body panel. In addition, the trim attachment bracket 1 further includes a bridging portion 6 that connects these bracket function portions (3, 4, 5) to each other.

The trim attachment bracket 1 of FIG. 1 has a structure in which portions other than the above-described bracket function portions (3, 4, 5) and the bridging portion 6 are opened as holes 7 having predetermined shapes as illustrated in FIG. 1. Meanwhile, these bracket function portions (3, 4, 5) and the bridging portion 6 are maintained in this structure.

### Details of Main Functions

### Joined Portion 3:

A joining method of welding the trim attachment bracket 1 to the automobile interior trim T by ultrasonic waves is adopted for a specific configuration example of the joined portion 3, in the trim attachment bracket 1 of FIG. 1. For this reason, the joined portion 3 is configured as the joined portion 3 where the trim attachment bracket 1 is welded to the automobile interior trim T. However, any of other joining methods may be adopted. Examples of other joining methods include a joining method of bonding the automobile interior trim T and the trim attachment bracket 1 to each other by an adhesive such as a hot-melt adhesive. The joined portion 3 is indicated by the dashed line in FIG. 1. This dashed line indicates an area against which a welding ultrasonic-wave cone contacts, and does not mean that an entire inside of this area is welded by ultrasonic waves.

### Clip Arrangement Portion 4:

The following configuration is adopted as a specific structure example of the clip arrangement portion 4, in the trim attachment bracket 1 of FIG. 1. This configuration includes a clip base 41 for installing and fixing the clip C. The clip base 41 is formed integrally with the bridging portion 6. The well-known clip C is fitted and installed to the clip base 41 and is thus arranged. However, there is no limitation to this. The clip C and the clip base 41 are known technical matters as disclosed in Patent Literature 1, for example, and thus, detailed description thereof is omitted.

### Contact Portion 5:

The contact portion 5 functions as countermeasure means. The countermeasure means prevents what is called a denting deformation phenomenon of the automobile interior trim T in a state where the automobile interior trim T is attached to the vehicle body panel via the trim attachment bracket 1.

The following structure is adopted as a specific structure example of this type of contact portion 5, in the trim attachment bracket 1 of FIG. 1. This structure includes a contact boss 51 having a projection shape. The contact boss 51 is formed integrally with the bridging portion 6. The contact boss 51 contacts against a contact surface of the unillustrated vehicle body panel.

A position of the contact boss 51 as described above can be appropriately modified depending on necessity. In the trim attachment bracket 1 of FIG. 1, a relatively large burden or load is applied to a portion between the two clips C and C and a portion around the clip C in work of attaching or detaching the clip C when the clip C is attached to or detached from the vehicle body panel. For this reason, the contact boss 51 is arranged at least between two clip arrangement portions 4 and 4. Thereby, a rigidity of the portion between the clips C and C is enhanced.

A contact rib having a rib shape may be adopted as another embodiment of this type of contact portion 5, instead of the above-described contact boss 51. An illustration of the contact rib is omitted. Alternatively, a projection other than the contact boss and the contact rib may be adopted as the contact portion 5.

The number and a shape of the contact portions 5 constituted by the contact bosses 51, the contact ribs, the projections, or the like as described above can be appropriately modified depending on necessity. The number and a shape of the contact portions 5 are not limited to the examples illustrated in FIG. 1.

### Bridging Portion 6:

The trim attachment bracket 1 of FIG. 1 is fabricated by a method (hereinafter, referred to as “mold forming”) of pouring a molten resin into a cavity in a mold, and thereby manufacturing the trim attachment bracket 1. Accordingly, the entirety of the bracket function portions (3, 4, 5) and the bridging portion 6 provided in the trim attachment bracket 1 of FIG. 1 is formed of the resin.

In the mold forming, a dimension of the bridging portion 6 is calculated in consideration of forming conditions such as fluidity of the resin in the mold and positions and the number of gates for supplying the molten resin into the mold. In the case of the attachment bracket 1 of FIG. 1, the minimum value of a width W of the bridging portion 6 is set in such a way as to be equal to or larger than 15 mm for the following reason. When the width is smaller than 15 mm, fluidity of the resin in the mold cavity is impaired. As a result, the entire cavity is not thoroughly filled with the molten resin, thereby causing the defective product to be produced. The minimum value of 15 mm is merely one example or an indicator, and may be appropriately modified depending on the above-described forming conditions.

Meanwhile, when a width of the bridging portion 6 is set larger than that necessary in the trim attachment bracket 1 of FIG. 1, a surface area of the bridging portion 6 is increased, and an area of the opening (specifically, the hole 7 having the predetermined shape) is decreased to that extent. As a result, the below-described working effect (reduction of surface shrinkage and warping) achieved by the hole (opening) 7 is cancelled. For this reason, the maximum value of a width of the bridging portion 6 is appropriately determined within a range in which such an working effect can be sufficiently exhibited.

### Hole 7 (Opening) of Predetermined Shape:

The trim attachment bracket 1 of FIG. 1 has the above-described opening (specifically, the hole 7 having the predetermined shape) structure, i.e., the structure in which the portions other than the bracket function portions (3, 4, 5) and the bridging portion 6 are opened as the holes 7 having the predetermined shapes. Thereby, (1) a ratio of a surface area occupied by the resin to an entire surface area (including surface open areas of the openings 7) in the trim attachment bracket 1 is reduced while a dimension (size) and the bracket function portions (3, 4, 5) necessary for the trim attachment bracket 1 are maintained. A rigidity of the entire trim attachment bracket 1 excluding the bracket function portions (3, 4, 5) is relatively low. Thereby, the trim attachment bracket 1 itself becomes flexible, and easily conforms to the shape of the automobile interior trim T. Surface shrinkage of the trim attachment bracket 1 and entire or partial warping of the trim attachment bracket 1 due to this surface shrinkage are effectively reduced. The surface shrinkage is caused by cooling solidification when the trim attachment bracket 1 is formed from the molten resin.

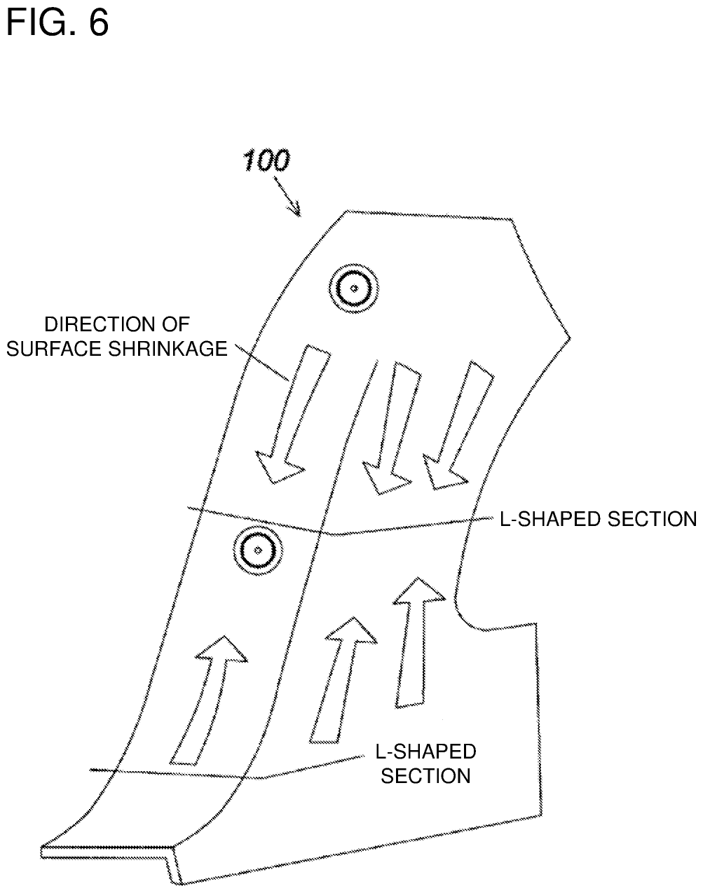

FIG. 6 is an illustration of a surface shrinkage direction in a conventional trim attachment bracket.

Referring to the same drawing, the conventional trim attachment bracket 100 includes a curve along a longitudinal direction and an L-shaped section (hereinafter, referred to as “the longitudinal-direction curve and the L-shaped section”) in one side area thereof. This point similarly applies to the trim attachment bracket 1 of FIG. 1.

The arrows in FIG. 6 indicate directions of the surface shrinkage in the conventional trim attachment bracket 100. A direction tendency of this surface shrinkage similarly applies to the trim attachment bracket 1 of FIG. 1.

Incidentally, in a case of the trim attachment bracket 1 of FIG. 1 including the longitudinal-direction curve and the L-shaped section as described above, the surface shrinkage and warping described above are likely to occur, particularly in an area of the longitudinal-direction curve and the L-shaped section, i.e., in the one side area of the trim attachment bracket 1. The inventor of the present invention has confirmed this point through analysis and experiment.

In view of it, a plurality of the holes 7 (openings) are arranged particularly in the one side area (the area of the longitudinal-direction curve and the L-shaped section) in such a way as to be aligned along the curve line CL, in a specific arrangement configuration example of the holes 7 (openings) having the predetermined shapes in the trim attachment bracket 1 of FIG. 1. The holes 7 (openings) aligned in such a manner divide the surface shrinkage in the trim attachment bracket 1 of FIG. 1. Thus, a ratio of the surface shrinkage of the trim attachment bracket 1 of FIG. 1 becomes smaller than that in the conventional trim attachment bracket 100. A plurality of the holes 7 enable a weight and material cost of the trim attachment bracket 1 to be reduced.

The present invention is not limited to the above-described embodiment. Those skilled in the art can modify the present invention variously within the technical idea of the present invention.

### REFERENCE SIGNS LIST

1 Automobile interior trim attachment bracket (trim attachment bracket)
3 Joined portion (bracket function portion)
4 Clip arrangement portion (bracket function portion)
41 Clip base
5 Contact portion (bracket function portion)
51 Contact boss
6 Bridging portion
7 Hole (opening)
C Clip
T Automobile interior trim

1. An automobile interior trim attachment bracket used as means for attaching an automobile interior trim to a vehicle body panel, the automobile interior trim being formed into a predetermined shape,
the attachment bracket comprising at least a joined portion, a clip arrangement portion, and a contact portion that are bracket function portions,
wherein the joined portion is joined to the automobile interior trim, a clip is arranged at the clip arrangement portion, the clip is fitted into an attachment hole in the vehicle body panel, the contact portion is caused to contact against the vehicle body panel,
the trim attachment bracket includes a bridging portion that connects the bracket function portions to each other,
a portion other than the bracket function portions and the bridging portion is opened as a hole having a predetermined shape while the bracket function portions and the bridging portion are maintained.

2. The automobile interior trim attachment bracket according to claim 1,
wherein the automobile interior trim is configured as a soft trim having a bending rigidity lower than that of the attachment bracket.
